(19) United States
(12) Patent Application Publication
(10) Pub. No.: US 2026/0146687 A1
(43) Pub. Date: May 28, 2026

(54) RETAINING DEVICE

(71) Applicant: GRIPZILLA NEW ZEALAND LIMITED, Flemington (NZ)

(72) Inventor: Francois Petrus van der Schyff, Flemington (NZ)

(21) Appl. No.: 19/400,220

(22) Filed: Nov. 25, 2025

(30) Foreign Application Priority Data
Nov. 28, 2024 (NZ) 816647

(51) Int. Cl. F16L 3/12; F16L 3/22

(52) U.S. Cl. CPC F16L 3/1211; F16L 3/221

(57) ABSTRACT

Disclosed is a retaining device comprising a retention channel to receive an element for retention and an over-centre latch to retain the element. The retention channel includes a sprung arm, having a first inner channel wall and a channel arm, having a second inner channel wall. The first and second inner channel walls form a clamping surface and a sprung arm is displaceable between an open position to admit the element for clamping and a closed position to clamp the element with the clamping surface by actuation of the over-centre latch. The over-centre latch includes a lever mechanism. The lever mechanism is configured to actuate the retention channel between an open position and a closed position. The actuation of the lever mechanism to the closed position displaces a sprung arm from the open position to the closed position and applies a force to retain the element with the clamping surface.

### CROSS-REFERENCE TO RELATED APPLICATIONS

This application claims priority to New Zealand Provisional Patent Application No. 816647 filed Nov. 28, 2024, entitled, ‘Retaining Device’, and is incorporated herein by reference for all purposes.

### TECHNICAL FIELD

The present disclosure relates generally to retaining devices, arrangements, assemblies and systems, and relates in particular to clamping devices, assemblies and systems.

### BACKGROUND

Any discussion of the prior art throughout the specification should in no way be considered as an admission that such prior art is widely known or forms part of the common general knowledge in the field.

Retaining devices, such as clamps and clips, are used in a wide range of applications, for example in: industrial, construction, medical, scientific, engineering, and domestic applications.

Various components such as conduits, tubes, tools, and the like, are secured to surfaces such as walls and ceilings with retaining devices.

Many retaining devices, operate on a press fit basis, requiring force to insert the element to be retained, for example, pipes or cables. A common drawback of clips of this type is that the resistance to withdrawal of the pipe or similar element or component is generally directly proportional to that of insertion. That is, the resistance to withdrawal of the pipe or similar article or component (which should be as high as possible to ensure effective retention), cannot be increased without causing a corresponding increase in the resistance to insertion, which on the other hand should be as low for ease of application. In order to ensure sufficiently safe retention, the resistance to insertion may be high so that there is an increased risk of damage to either the clip or the element to be retained by the clip due to the force required.

Retaining devices and arrangements that are: lightweight, versatile, inexpensive to manufacture, easy to operate, resistant to vibration, and with sufficient clamping or grip force for a variety of applications are desirable.

Also desirable are retaining devices actuable without the use of undue force or pressure and that the device may be easily secured to a support.

Options, or alternatives for clamps and clips, which can be used in industrial, construction, medical, scientific, engineering, and domestic applications, are desirable.

### SUMMARY

The claimed subject matter is not limited to embodiments that solve any disadvantages or that operate solely in environments such as those described above. This background is only provided to illustrate examples of where the present disclosure may be utilised.

The present disclosure seeks to improve, or at least provide alternative retaining arrangements.

In an aspect, the disclosure provides a retaining device comprising: a retention channel adapted to receive an element for retention within the channel; and, an over-centre latch actuable to retain the element in the retention channel, wherein the retention channel comprises; a sprung arm, having a first inner channel wall; and, a channel arm, having a second inner channel wall, wherein the first and second inner channel walls form a clamping surface within the retention channel, and wherein a sprung arm is displaceable between an open position to admit the element for clamping and a closed position to clamp the element with the clamping surface, by actuation of the over-centre latch; and, wherein the over-centre latch comprises: a lever mechanism including: a lever arm; and, a rotable linkage element, said lever mechanism configured to actuate the retention channel between an open position and a closed position; and, wherein actuation of the lever mechanism to the closed position displaces a sprung arm from the open position to the closed position and applies a constrictive force upon the element to retain the element with the clamping surface.
preferably, the cross-sectional area of the retention channel opening is constricted by actuation of the lever mechanism to the closed position.

In some embodiments, the clamping surface of the retaining device may be comprised of teeth.

Suitably, a sprung arm may include a pivot hub.

Suitably, actuation of the lever mechanism to the closed position pivots the rotable linkage element of the lever mechanism urging the latch to the over-centre position.

In some embodiments, the retaining device further comprises a static arm including a pivot hub wherein the lever mechanism is formed between the pivot hub of the sprung arm and a pivot hub of a static arm.

In embodiments, the retaining device further comprises a support structure.

Suitably, the sprung arm, channel arm and static arm extend from the support structure.

Suitably, the support structure further comprises a base.

In some embodiments, the over-centre latch is securable in a locked position when in an over-centre position.

Optionally, the latch self-secures in an over-centre position at a stop of the over-centre mechanism.

Suitably, the stop comprises the front shoulder of a pivot hub of the lever being impeded from further travel by the sprung arm. Suitably, the front shoulder of a pivot hub of the lever are impeded from further travel by a rear shoulder of sprung arm.

The retaining device may be selected from a clamp or clip.

In some embodiments, the retaining device further comprises a reducing collar insert matingly engagable within the retention channel of the device. Suitably, the collar reduces the cross-sectional area of the retention channel.

In an aspect the disclosure provides a retaining system comprising: a retaining device; and a platform for arranging one or more retaining devices thereon.

Suitably, the retaining devices are secured on a surface of the platform by fastening the support structure of the retaining device to the platform.

In some embodiments, the support structure of the retaining device is integral with the platform.

In some embodiments, the retaining system may comprise an array of retaining devices. Suitably, the system comprises a rail of retaining devices.

In an aspect the disclosure provides for an assembly of retaining devices.

Suitably, the over centre-latch includes a lever mechanism.

Suitably the over-centre latch includes a stop.

Suitably the lever mechanism actuates the latch.

### BRIEF DESCRIPTION OF DRAWINGS

The accompanying drawings, together with the detailed description provided below, describe exemplary embodiments of the disclosure. Like reference numerals refer to like elements throughout the various views of the drawings. The drawings are not to scale and the proportion of certain elements may be exaggerated for the purpose of illustration. The invention will now be described, by way of example, with reference to the accompanying drawings, in which:

FIG. 1A illustrates a forward tilted side perspective view of an embodiment of the present disclosure with the lever in the open position;

FIG. 1B illustrates a side perspective view of an embodiment of the present disclosure with the lever in the closed position;

FIG. 2A illustrates a forward tilted side perspective view of an embodiment of the present disclosure with the lever in the open position;

FIG. 2B illustrates a side perspective view of an embodiment of the present disclosure with the lever in the closed position;

FIG. 3A illustrates a counterclockwise rotated backward tilted rear perspective view of an embodiment of the present disclosure with the lever, pivot pins and linkage element removed;

FIG. 3B illustrates a backward tilted plan perspective view of an embodiment of the present disclosure with the lever, pivot pins and linkage element removed;

FIG. 3C illustrates a side perspective view of an embodiment of the present disclosure;

FIG. 4A illustrates a forward tilted side perspective view of an embodiment of the present disclosure clamping a rectangular cuboid;

FIG. 4B illustrates perspective view of an embodiment of the present disclosure clamping a rectangular cuboid;

FIG. 5A illustrates a clockwise rotated rear perspective view of an embodiment of the present disclosure;

FIG. 5B illustrates a perspective view of a multi-channel clamping apparatus of the present disclosure;

FIG. 6A illustrates an anticlockwise perspective view of a clamp rail with clamping devices secured thereon;

FIG. 6B illustrates a forward-tilted perspective view of a clamp rail with clamping devices secured thereon;

FIG. 6C illustrates a perspective view of a clamp rail securing clamping devices with the clamping devices retained in the rail in different orientations;

FIG. 7A illustrates an embodiment of a reducing collar;

FIG. 7B illustrates an alternative embodiment of a reducing collar;

FIG. 7C illustrates mating engagement of a reducing collar with a retaining device; and,

FIG. 8 illustrates a comparison of lever arm orientations of different retaining device embodiments.

### DETAILED DESCRIPTION

As a preliminary matter, it will be readily understood by one having ordinary skill in the relevant art that the present disclosure has broad utility and application.

The foregoing summary and following detailed description are merely exemplary in nature and are not intended to limit the described embodiments or the application and uses of the described embodiments. All of the exemplary implementations below are provided to enable persons skilled in the art to make or use the embodiments of the disclosure and are not intended to limit the scope of the disclosure. Furthermore, there is no intention to be bound by any expressed or implied theory presented in the preceding technical field, background, summary or the following detailed description. It is also to be understood that the specific apparatus, systems and processes illustrated in the attached drawings, and described in the following specification, are simply exemplary embodiments of the inventive concept. Specific dimensions and other physical characteristics relating to the embodiments disclosed herein are therefore not to be considered as limiting unless the claims expressly state otherwise.

Any sequences(s) and/or temporal order of steps of various processes or methods that are described herein are illustrative and not restrictive. Accordingly, it should be understood that although steps of various processes or methods may be shown and described as being in a sequence or temporal order, the steps of any such processes or methods are not limited to being carried out in any particular order or sequence, absent any indication otherwise. Indeed, the steps in such processes or methods generally may be carried out in various different sequences and orders while still falling within the scope of the present disclosure.

Additionally, it is important to note that each term used herein refers to that which an ordinary artisan would understand such term to mean based on the contextual use of such term herein. To the extent that the meaning of the term used herein - as understood by the ordinary artisan based on the contextual use of such term - differs in any way from any particular dictionary definition of such term, it is intended that the meaning of the term as understood by the ordinary artisan should prevail.

Furthermore, it is important to note that as used herein “a” and “an” generally denote “at least one” but does not exclude a plurality unless the contextual use dictates otherwise. When used herein to join a list of items, “or” denotes “at least one of the items”, but does not exclude a plurality of items of the list. Finally, when used herein to join a list of items, “and” denotes “all of the items of the list”.

The present disclosure contains headers. It should be understood that these headers are used as references and are not to be construed as limiting upon the subject matter disclosed under the header.

As used herein, the term “about” when used with a numerical value, means the numerical value may vary by at least ±10%.

As used herein, the term “clamp” refers to a brace, band, or clasp for strengthening or holding things together. The term also may also be used as a verb meaning to fasten or to hold (an element, object or (some)thing) in place.

As used herein, the term “clip” refers to a flexible or spring-loaded device for holding an object or objects together or in place. The term also may also be used as a verb meaning to fasten or to hold (an element, object or (some)thing) in place.

It is to be understood that the term “retaining device” may broadly encompass any device configured to hold an object in a location and includes devices such as clips and clamps.

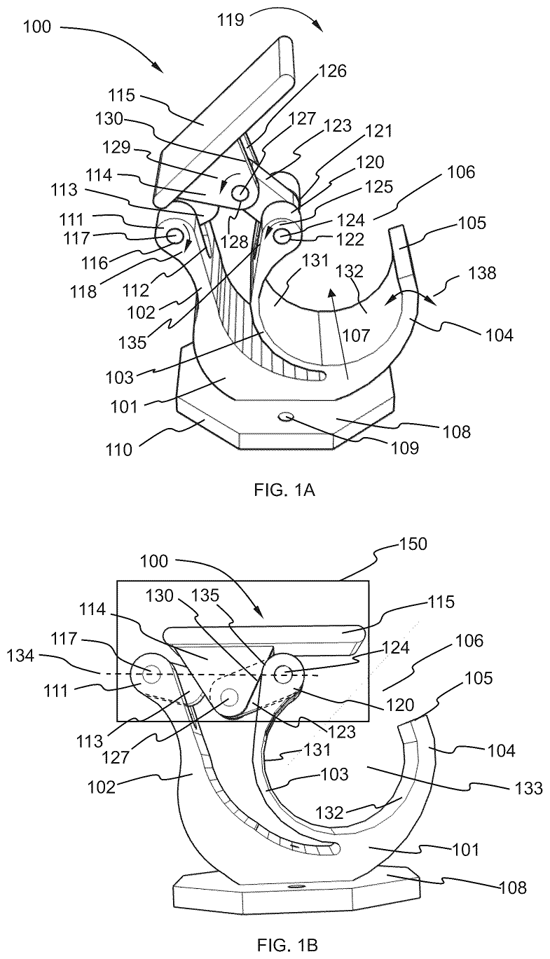

FIG. 1A illustrates a retaining device 100 in the open position whilst FIG. 1B illustrates a retaining device in the closed position.

Considering FIG. 1A, illustrated is an embodiment of a retaining device 100 of the present disclosure. The retaining device 100, is comprised of a body or support structure, and a clamp assembly comprising a retention channel and an over-centre latch assembly. Suitably, the device comprises a base. The illustrated embodiment 100 may suitably be referred to as a clamp or clip. The illustrated embodiment 100, has a body 101 from which extends a static arm 102, a sprung arm 103 and a channel arm 104. The channel arm 104 terminates in a lip 105 at an opening 106 between the sprung arm 103 and channel arm 104. In the embodiment illustrated, the static arm 102 and channel arm 104 are formed to be substantially rigid, whereas the sprung arm 103 is resilient, that is, meant to be subject to deformation.

Whilst the channel arm is considered substantially rigid and largely fixed compared to the more easily deformable sprung arm, this does not preclude the possibility of a small degree of play, or flex, of the channel arm. That is the term “substantially” indicates that the term “rigid” should not be read too literally. In some instances, the channel arm may considered as a buttress or support arm, which designed to give slightly upon application of a load. The amount of flex of the arm depends upon such variables as the materials of construction and the designed rigidity of the arm as implemented, for example, by the width of the arm (where the width may be used as a proxy for deformability) and density of material of construction. Suitably, the degree of flex may be from about 0.01 degree to about 3 degree, from about 0.05% to 2.0 degree, from about 0.1 degree to about 1.0 degree and from about 0.02 to about 0.05 degree. The flex is considered as a degree of flex relative to the rest position of the arm. The arrow 138 indicates the direction of slight outward flex (arm moving to open the channel) and return flex. Suitably, the slight degree of flex of the static arm may allow for incorporation of a slightly oversized element to be retained (relative to the retaining channel).

Both the static arm 102 and channel arm 104 broaden towards their bases whilst the resilient arm 103 is sufficiently narrow from the base to enable a greater degree of flex. An element or object to be clamped (not shown) may be guided into the retention channel formed between the sprung arm 103 and channel arm 104 (refer to FIG. 1B, retention channel 133), as indicated by the directional arrow 107, alternatively through the opening 106, when the sprung arm 103 is in the open position. The sprung arm has an inner clamping surface 131 and the channel arm 104 has an inner clamping surface 132, which, as in the present embodiment, may form a continuous surface. The clamping surfaces 131 and 132 are the surfaces which are in contact with the element retained in the retention channel 133 when the lever mechanism (indicated within box 150) is actuated to the clamped position by actuation of the lever. Actuation of the lever mechanism to the closed position pivots the linkage element of the lever mechanism urging the latch to the over-centre position.

The dimensions of the static arm 102, sprung arm 103 and channel arm 104 may be varied, depending on the size of the clamping assembly and the intended application. By way of example, a clamp, such as embodiment 100, formed from polypropylene, with a retention channel 133 diameter of about 35 mm, has a static arm 102 that tapers to a width of about 4 mm, a channel arm that tapers to about 4 mm towards the lip and a sprung arm with a width of about 2 mm. Variations in widths, resilience and stiffness of the arms may depend on materials, for example, the selection of type of plastic used.

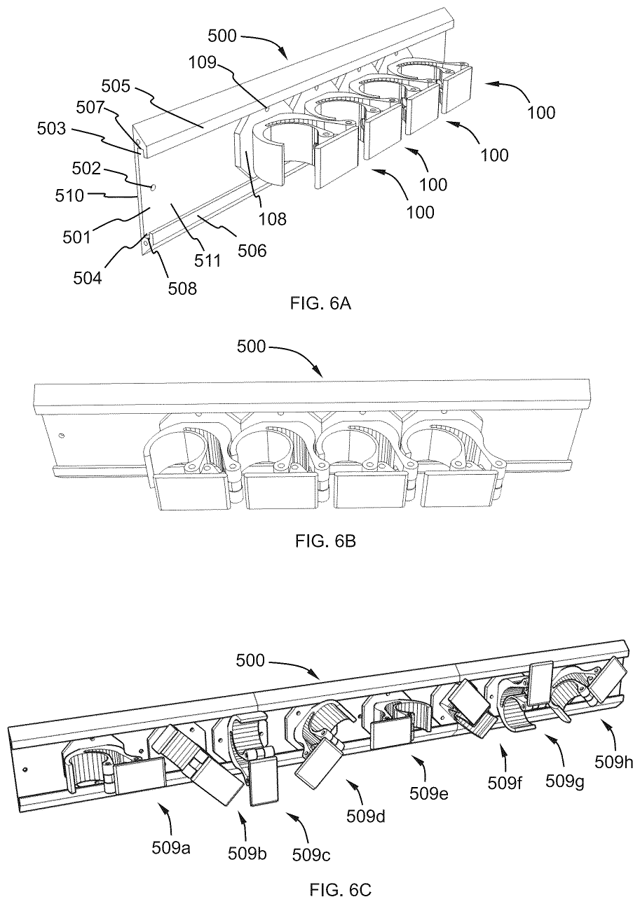

In illustrated embodiment 100 of FIG. 1A, the clamp body 101 is integral with a base 108, which may be used to affix the device 100 to the surface of a structure such as a wall, roof or ceiling. The device 100 may be affixed, for example, by means of fastening aperture 109 (of which there may be one or more of) with a fastener such as a screw or nail passed through the aperture and secured into the surface of a structure. The fastening aperture may be a threaded aperture. The shape of the base 108 is octagonal 110 which may be used to orient the device 100 when secured, for example, with a retaining rail (see FIGS. 6A to 6C), in a longitudinal or latitudinal orientation.

Referring to FIGS. 1A and 1B, the retaining device 100 is comprised of a lever mechanism 150, the constituent parts of which are described further herein. A pivot hub 111 is disposed at the distal end of the static arm 102. The pivot hub is bifurcated, or forked, with a channel 112 formed between the forks. Arranged in channel 112 between the two pivot hub portions is a lever linkage bar 113 formed integrally with the lever pivot hub 114, which forms part of the lever 115. The static arm pivot hub 111 has apertures 116 formed through both hub portions which align with an aperture located distally in the lever link bar (not shown) when the lever linkage bar 113 is arranged in channel 112. A pivot pin 117 is insertable through the pivot hub apertures 116 and the lever link aperture to retain the lever linkage bar 113 in a pivotable engagement with the static arm hub 111. The lever link 113 rotates in a clock wise direction, as indicated by directional arrow 118 when the lever 115 of the clamping device 100 is actuated to the closed position and counter clockwise when the lever 115 is actuated to the open position. The channel 112 allows for rotational passage of the lever link about an axis described by the cross-alignment of the pivot hub apertures 116. The closed or locked direction of the lever 115 is also indicated by directional arrow 119.

Similarly to the static arm 102, the sprung arm 103 also has a bifurcated pivot hub 120 with a channel 121 formed between the bifurcated arms of the hub 120. The hub 120 is located distally on the sprung arm 103 and has apertures 122 the cross alignment of which forms an axis of rotation of rotable linkage element 123 within the hub. Expanding further, arranged in channel 121 between the two arms of the bifurcated hub 120 is one end of the over-centre linkage element 123. The over-centre linkage 123 has an aperture (not shown) that is alignable with the cross axis of apertures 122 of the sprung arm pivot hub 120 such that a channel is formed through the over-centre linkage and the pivot hub apertures by alignment of the apertures. A pivot pin 124 is passed into and through this channel to retain the over-centre linkage 123 within the pivot hub 120 such that the retained end of the over-centre linkage 123 may be rotated about the pivot hub 120. The counter-clockwise directional arrow 125 indicates the direction of travel of the over-centre linkage element 123 when lever arm 115 is urged to the closed or locked position as indicated by directional arrow 119. The opposing end of linkage element 123 is retained in the lever pivot hub 114 which is also bifurcated forming a channel 126 to allow arrangement within the channel 126 of the linkage element 123. In a similar manner as described earlier for other pivot points in clamping device 100, the linkage element 123 is retained in place by a pivot pin 127 which passes through the apertures 128 and a corresponding aperture in the rotable linkage element 123 (also referred to as a linkage bar). The pivot pin 127 defines the instance centre of the over-centre linkage. The directional arrow 129 indicates the direction of rotation of linkage element in relation to the housing 114. The retaining device of any one of the preceding claims wherein actuation of the lever mechanism to the closed position pivots the linkage element of the lever mechanism urging the latch to the over-centre position

Suitably, the dimensions, for example, length of the rotable linkage element, may be modified.

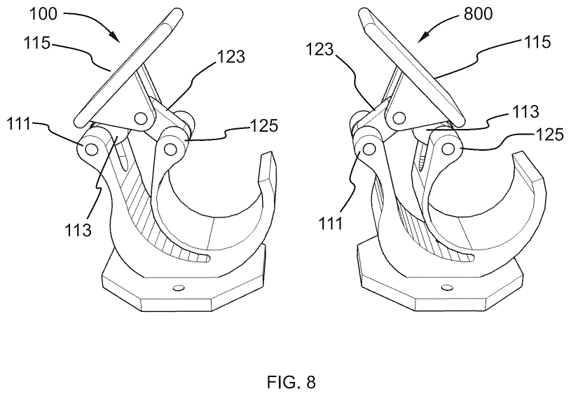

Referring to FIG. 8, illustrated is a comparison of a retaining device 100 with a retaining device 800, wherein in retaining device 800 the orientation of the lever element has been reversed. Both retaining devices function in the same way. Referring to device 100, the rotable linkage element 123 is coupled between sprung hub 125 and the hub of the lever arm 115. And the lever linkage element 113 is couple to the static hub 111. In the alternative embodiment 800, the rotable linkage element 123 is coupled between the static hub 111 and the hub of the lever arm 115, and the lever linkage element 113 is coupled to the sprung hub 125. This change in the coupling arrangement of the lever mechanism reverses the orientation of the lever arm 180°.

The centre position of the over-centre linkage can be defined by line scribed from the axis of pin 117 to the axis of pin 124. That is a line scribed through the centre of and perpendicular to the axes of rotation of pins 117 and 124. In the open or release position, the pivot pin 127 is above the plane of this line and in the closed or clamped position the pivot pin is below the plane of this line. The latch is in the centre position when the axes of pivot pins 117,127 and 124 align in the plane of this line.

Considering FIG. 1B, as previously indicated, the clamping device 100 is illustrated in the closed or clamped position. The centre position of the over-centre linkage is indicated by hashed line 134. The pivot pin 127, which retains one end of the linkage element 123 in the lever pivot housing 114 is under this line in the closed or clamped position. The front shoulder 130 of housing 114 is retained against the rear shoulder 135 of the pivot housing 120 of the sprung arm 103.

The clamp latch has an over-centre lock point; whereby once actuated to the end of travel in the over-centre position, the lever is securely locked in place at the lock point. The lever self-secures due to the force from the sprung arm against the latch when the latch has passed the over-centre lock point but the over-centre mechanism has not travelled so far as to release all of the energy from the sprung arm (the arm is still partially deformed). This is due to a stop in the over-centre mechanism generated from the front shoulder of the lever pivot hub being impeded from further travel by the sprung arm. The lever cannot be moved or unlocked unless a certain amount of force is used to pull the lever and get over the over-centre position.

By way of further explanation, an over-centre linkage is a type of mechanical linkage that may be used to provide locking or latching mechanisms in a variety of applications. An over-centre linkage typically consists of a series of links or bars that are connected by pivoting joints, which can be actuated by a range of input methods such as levers, cams or springs. The basic principle of an over-centre linkage is that it uses a mechanical advantage to create a locking or latching mechanism by utilizing the point at which the linkage goes over-centre. The force required to actuate the linkage increases as it approaches the point of over-centre, and then decreases as it passes this point, creating a self-locking mechanism by a stop mechanism, in this case, through retention of potential energy within the sprung arm. The point of over-centre, or centre point, is usually the point where both bars of the linkage are parallel. In the present embodiment, the centre-point is when pivot pins 117, 127 and 124 are aligned parallel.

Considering both FIGS. 1A and 1B, the static arm 102 holds position (i.e. is not deformed) whilst the sprung arm 103 is deformed by the urging of the linkage element 123 as the over-centre linkage heads to the centre position. The linkage passes through the centre position to a latched position, which is established by the sprung or resilient arm 103 acting as a stop for the pivot hub 114 of the lever 115. In the latched position, the distance between the centre axes of pivot pins 117 and 124 is greater than in the open or released position. A force generated from the partial deformation or bending of the sprung arm 103 holds the shoulder 130 of lever 115 in place retained against the back face 135 of pivot hub 120.

As an analogy, in order to describe the clamping mechanism, if the inner surfaces 131 and 132 are understood to describe a semicircular shape, then the semicircle described by the surfaces in the closed position would be approximately concentric to the semicircle in the open position but of a smaller radius. This constriction provides the clamping mechanism. The force from the over-centre linkage retains the lever arm in place in the closed or clamped position.

The design of an over-centre linkage requires consideration of factors such as the required force and travel distance, materials of construction, the size and shape of the links and pivoting joints, and the required actuation mechanism. Additionally, the over-centre angle must be selected to ensure that the linkage functions correctly and provides the required locking force.

Referring to FIG. 1B hidden portions of the linkage element 123 are indicated by dashed lines as are hidden portions of bar 113.

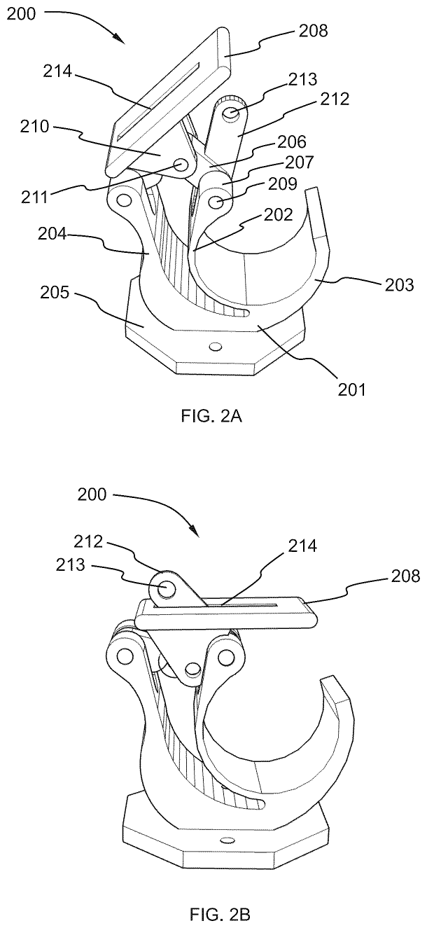

Referring now to FIG. 2A, illustrated is a further embodiment of the present disclosure, clamping apparatus 200. In FIG. 2A the apparatus is shown with the latch assembly in the open or release position. Apparatus 200 is comprised of a body 201, sprung arm 202, channel arm, 203, static arm 204 and base 205. The embodiment 200 is also comprised of an over-centre latch assembly, which is utilised to actuate clamping with the device. The latch assembly includes the linkage element 206 coupled to a distal hub of sprung arm 202 with a pivot pin 209 and coupled to a second pivot hub 210 of lever 208 with a pivot pin 211. A feature of apparatus 200 is the presence of an additional locking mechanism. The additional locking mechanism includes locking arm 212, aperture 213 and channel 214 in lever arm 208. The locking arm 212 is formed integrally with the linkage element 206. The arm 212 is arranged such that when the lever 208 is moved from the open position to the closed position, the locking arm 212 passes through channel 214 in the lever 208. FIG. 2B illustrates the clamping apparatus in the closed position. The locking aperture 213 of locking arm 212 has travelled through channel 214 in lever 208. A pin, tie or padlock, for example, may be inserted into aperture 213 in order to further prevent lever arm 208 returning to the released position, such as might occur through accidental application of force to the lever.

The additional locking mechanism provide an additional level of security against accidental opening of the clamping mechanism such as might be prudent when used in permanent installations of pipes, cables and other conduits in aircraft, vehicles and household installations such as solar installations, plumbing and electrical.

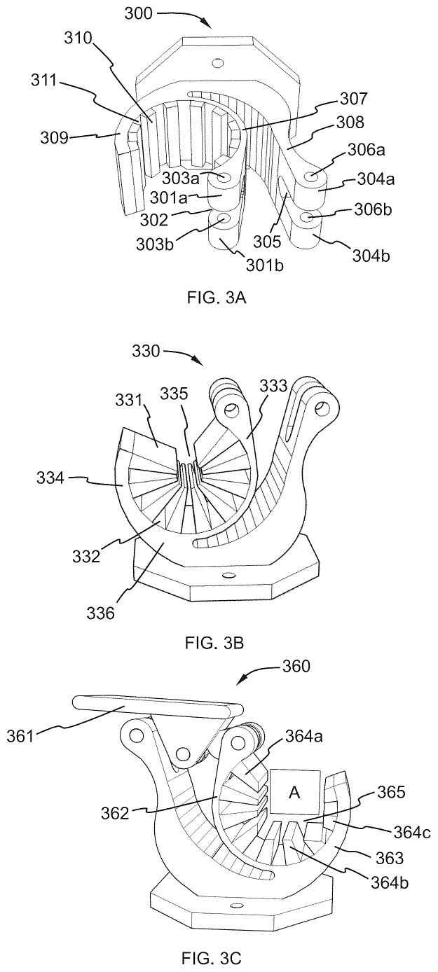

Turning now to FIG. 3A, illustrated is an embodiment 300 with the pivot pins, linkage element and lever removed. As previously outlined, the distal end of the resilient arm 307 forms a bifurcated (or forked) hub 301a and 301b, with a channel 302 formed therebetween for accepting the linkage element. The apertures 303a and 303b respectively in each hub fork 301a and 301b, are aligned with each other, for receiving a pivot pin therethrough to retain, and allow the pivoting of, a linkage element in the channel 302 between the two hub portions 301a and 301b. The more rigid channel arm 309, together with the resilient or sprung arm 307, forms the retention channel. Typically, the channel arm has a second inner channel wall that is opposed to the inner channel wall of the sprung arm. The static arm 308 also terminates in a bifurcated housing 304a and 304b for retaining the lever of the latch assembly in the channel 305 formed therebetween. The embodiment 300 has an arrangement of tooth-like protrusions 310 extending from the inner surface 311 of the arms 307 and 309. In certain circumstances protrusions may be disposed upon, or formed integrally with the surface of the retention channel, to facilitate the clamping of elements in the retention channel. As mentioned, the arrangement of dentate structures 310 may be formed integrally (e.g. moulded) with the arms 307 and 309 or may be affixed to the inner surface 311 of the retention channel, for example, with an adhesive. The dentate lining may be comprised of a resilient material such as felt, cork or rubber. Suitably, the lining may also be continuous extending over the entire inner surface of the retention channel.

Similarly to the previous figure, FIG. 3B illustrates an embodiment 330 with the pivot pins, linkage element and lever removed. The embodiment of FIG. 3B illustrates an alternative arrangement of teeth 331 on the inner surface 332 of the retention channel of the clamping assembly. The retention channel is formed by sprung arm 333 and channel arm 334 both of which extend from a support structure 336. In embodiment 330, the teeth 331 are elongated with a more pronounced and narrower apical edge. The elongation of the teeth narrows or constricts the retention channel orifice 335 suitably for the clamping of narrower diameter objects, for example, pipes and cables.

Optionally, the configuration and/or shape of the teeth within the retention channel may be altered to accommodate elements to be retained of differing dimensions and cross-sectional shapes. By way of example, the embodiment 360 of FIG. 3C, shown with the over-centre lever 361 in the closed position, illustrates an alternative dentate arrangement on the inner surfaces of the resilient arm 362 and opposing channel arm 363 of the clamp assembly. The relative lengths and shape of the teeth have been formed to receive an element with a rectangular cross-section area shape. In particular, the teeth have been formed to generate three sides 364a, 364b and 364c, so as to receive a rectangular element for clamping as indicated by shape A. The shape A is not meant to represent an actual element being clamped, merely employed to illustrate the outline of the shape of retention channel 365. The teeth may protrude to partially or completely cover the continuous inner surface of the retention channel.

The opposing resilient arm and the channel arm are capable of acting in a jaw like manner with the teeth disposed on the inner surface of the arms further assisting in clenching the element to be grasped or gripped by the clamp. The resilient arm acts as a sprung jaw, which is movable under force to a clamped position returning to a rest or open position if the force is released.

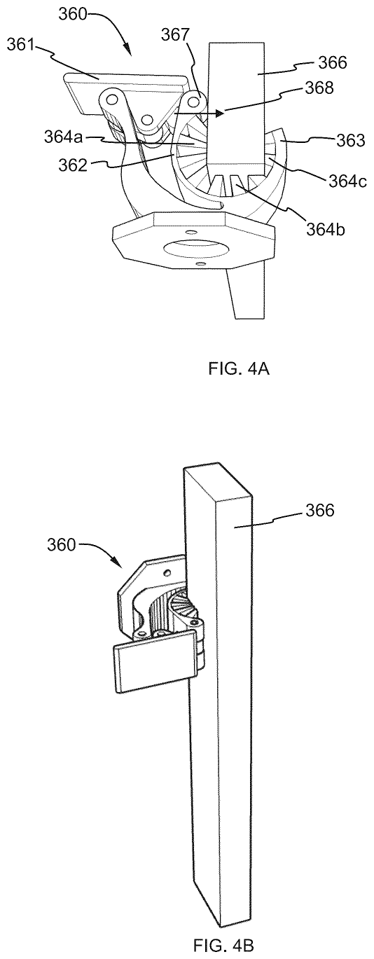

FIG. 4A illustrates a rearward overhead perspective view of the embodiment 360 of FIG. 3C, with the lever 361 of the over-centre latch in the closed position, retaining a rectangular cuboid 366, that is, an element with a rectangular cross-sectional shape. As previously outlined, the actuation of the lever to the closed position urges the sprung arm 362 towards the channel arm 363 constricting the cross-sectional area of the orifice of the retention channel. When the latch is moved to the closed position, the hub 367 is urged or driven from its rest position to a closed position towards the channel arm 363 as indicated by directional arrow 368. The reduction in cross-sectional area provides the basis for the clamping mechanism. The teeth 364c of the rigid arm 363 are substantially unmoved, whilst the teeth 364a, which are located on the resilient arm 362, move generating a clamping force in concert with the opposing teeth 364c and underside teeth 364b. FIG. 4B illustrates a front facing elevation perspective view of clamp 360 retaining the element 366 with a rectangular cross-sectional shape.

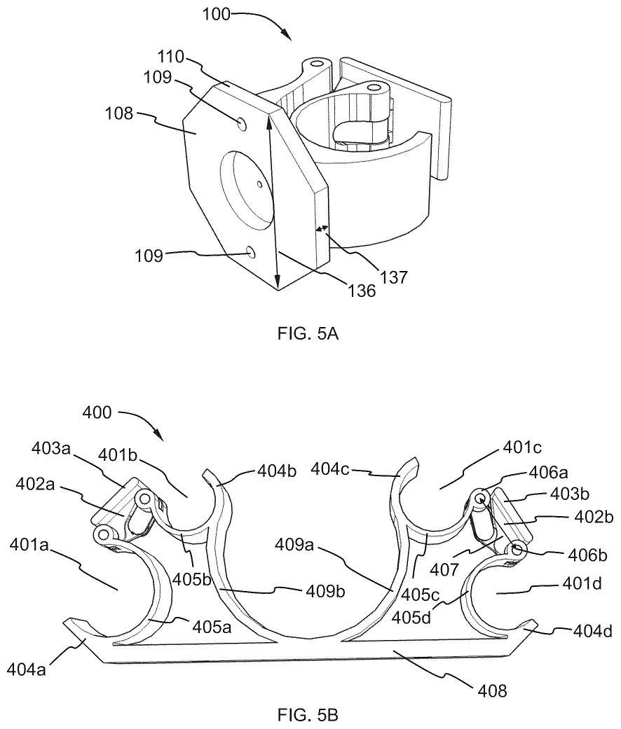

FIG. 5A illustrates an underside perspective view of embodiment 100 of the present disclosure. The base 108 of the clamp may be further modified to retain objects. For example, a magnet may be fixed, for example glued, to the underside surface of the base. With this modification, the retaining channel may be used to fasten the clamp to a elongate element, such as an over-head handle within a vehicle, and a metallic item, for example, a mobile phone may be then attached to the magnet. Similarly, the underside of the base 108 may be modified with a clip for retaining a device such as GPS device or a mobile phone and the retaining channel attached to an elongate element to allow for easy viewing of the device.

FIG. 5B illustrates a further embodiment 400 of the present disclosure. The illustrated embodiment 400 has four retaining channels: 401a, 401b, 401c, 401d, each of which are circular in cross-sectional shape but may be of different dimensions (cross-section area and shape). The clamping apparatus 400 is comprised of two latch assemblies 402a and 402b each assembly including a lever arm 403a and 403b respectively. The levers 403a and 403b are illustrated in the closed or clamped position. In the illustrated embodiment 400, each latch assembly is associated with two retention channels, latch assembly 402a with retention channels 401a and 401b and latch assembly 402b with retention channels 401c and 401d. Similarly to other embodiments disclosed herein, the retaining channels are comprised of a rigid arm 404a-d and a sprung arm 405a-d for the respective channels 401a-d. The rigid and sprung arms extend from the support structure comprised of elements 408 and 409a and 409b. In the present embodiment 400, actuation of the clamping lever urges the sprung arm towards the rigid arm in order to clamp an element appropriately disposed in the clamping channel. In the present embodiment 400, the clamping assembly is configured such that actuation of the lever to the closed position simultaneously urges the sprung arms of a channel pair towards their respective opposing channel arms thereby creating a dual clamping mechanism with the actuation of only one lever. For example, the actuation of lever 403b (as mentioned shown in the closed position) simultaneously urges sprung arm 405c towards rigid arm 404c and also drives sprung arm 405d towards 404d. Arrow 407 indicates the displacement between pivot hubs 406a and 406b. When latch 402b is in the open position the distance between the hubs indicated by arrow 407 is less than the distance between the hubs when the lever is locked in the over centre position. This change in displacement, and the locking of latch in the over centre position, provides for the simultaneous dual clamping mechanism for channels 401c and 401d.

In the embodiment of, for example, FIG. 1A, the resilient arm was coupled to a static arm such that the actuation of the lever to the closed position drove the resilient arm by the cam-like movement of a linkage element coupled to the lever. The static arm was rigid during actuation of the over-centre mechanism resulting in movement solely of the sprung arm. In contrast, in the present embodiment, the lever is coupled to two resilient arms and consequently during actuation of the over-centre linkage both of the arms is urged to a clamped position by lever linkage components.

Various arrangements of a support structure with a clamp assembly comprising the over-centre linkage and retention channel are contemplated. For example, the channel arm of the retention channel may be a second sprung arm also coupled to an opposing latch mechanism such that two latches are employed to drive two sprung arms to retain an element within the retention channel formed by the two sprung arms.

FIGS. 6A to 6C illustrate perspective views of a platform 500 for securing one or more retaining devices, for example as an array of retaining devices, to provide retaining systems and assemblies. The platform may be configured, for example as a rail arrangement according to the embodiments of FIGS. 6A to 6C. Considering first FIG. 6A, the rail arrangement 500 (also referrable to as a clip or clamp rail), is comprised of a base 501 which has an upper outward facing surface 511 and lower surface 510, apertures 502 for fixing the rail to a surface, such as a wall, an upper channel 503, and a lower channel 504, the upper channel formed by downwardly disposed upper lip 505 and the lower channel by an upwardly disposed lower lip 506. When fastening the rail to a surface such as a wall, the lower surface 510 of the base is placed against the wall surface. The distance from the base 507 of the upper channel to base 508 of the lower channel is approximately the same as the distance across the base of a clamping apparatus (see FIG. 5A, indicative dimensional arrow 136) and the channel widths are approximately the same as the width of the base of a clamping device (see FIG. 5A, indicative dimensional arrow 137). The rail channel width is described by the distance between the upper surface of the rail base and the inner surface of the lip. The channel 503 and channel 504 dimensions are configured such that the base 108 of a clamping device may be slidably engaged within and retained by the channels of the rail with the overhanging lip portions 505 and 506 retaining the base 108 in place. The apertures 109 of the clamping device (see also FIG. 5A) may be threaded on the inside so that grub screws may be used to secure the clips within the rail, when used therewith. When not used with the rail, the grub screws may be removed and normal screws/anchors can be used to secure the clip to a surface.

As illustrated in FIG. 6A, a series of clamping devices 100 may be held by a rail. Portions of the base 108 are located behind front lips 505 and 506 of the rail 500 which act as stops and assist in retention of clamp bases 108 within the rail. Typically, due to tolerances and inconsistencies such as surface irregularities and possible minor deformations, in order to allow for relatively unimpeded sliding engagement of the device base in the channel, the channel dimensions are slightly oversized compared to the base dimensions.

FIG. 6B illustrates a forward elevation overhead (tilted downward) perspective view of four clamping devices retained by a rail.

FIG. 6C illustrates eight clamping devices retained by the rail 500 where the clamping channels devices are shown oriented in different directions from rotation of the bases of the clamping devices. Returning briefly FIG. 5A, the base 108 of the embodiment displayed is octagonal in shape. Due to this octagonal shape, the base may be rotated in 45-degree increments and slidingly engaged with the rail to allow for a range of orientations within the retaining channel through rotation of the base thought a range of 45 degree orientations with respect to the rail. Similarly, a square base would allow for a range of 90-degree orientations of the clamping device with respect to the rail (with 90-degree rotations of the base), and a hexagonal base a range of 60-degree orientations.

Returning to FIG. 6C eight clamping devices are shown retained by the rail. From left to right, and considering the first device 509a as in the home position, the second device 509b is retained rotated 45 degrees clockwise to the first device, the third device 509c 90 degrees clockwise, the fourth device 509d 135 degrees clockwise, the fifth device 509e 180 degrees clockwise, the sixth device 509f 225 degrees clockwise, the seventh device 509g 270 degrees clockwise and the eighth device 509h 315 degrees clock wise from the first device.

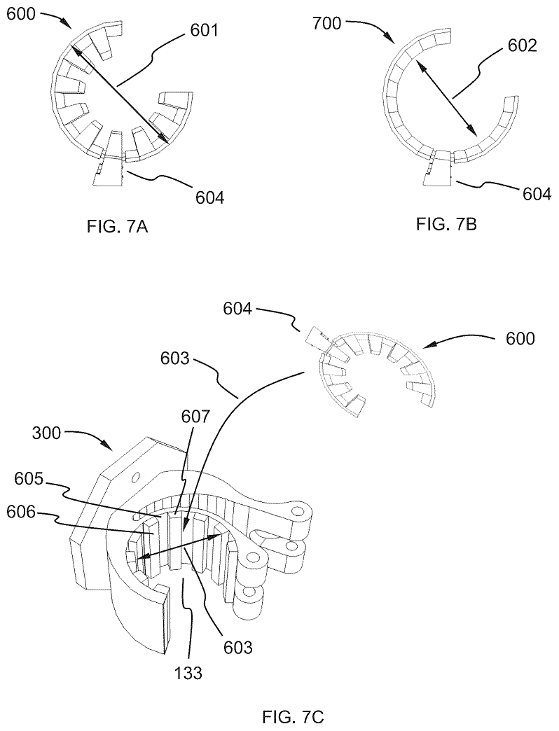

FIG. 7A and FIG. 7B illustrate inserts 600 and 700 respectively. Inserts 600 and 700 are used to reduce the cross-sectional area of the retention channel 133 of a clamping device 300 (see FIG. 7C). The inserts function as reducing collars and are adapted to be matingly received within, and constrict in concert with, the retention channel. FIG. 7A illustrates the outer diameter of the insert (as indicated by arrow 601). FIG. 7B illustrates the smaller internal cross-sectional area (as indicated by arrow 602) compared to the outer diameter. Referring to FIG. 7A, the shape and size of the insert are adapted so that the insert fits snugly within the retention channel of a clamping device. The outer diameter 601 of the insert, corresponds to the inner diameter of the retention channel 133 of a retaining device 300 (see FIG. 7C). The inner diameter (indicated by arrow) 603 of the retention channel 133 and the outer diameter 601 of the insert 600 are about commensurate in diameter allowing for fitting. That is, tolerances, and, for example, the flexibility of the sprung arm, may allow for the insert to be slightly oversized or undersized. When fitted, the outer wall of the insert is flush with the inner clamping surface of the retention channel of the clamping device and the inner wall of the insert forms the new inner wall of the retention channel. As illustrated in FIG. 7C, the insert 600 is engagable (indicated by the directional arrow within the retention channel 603). The insert 600 may be fitted by sliding the insert into the retention channel 133 of a retaining device 300. Referring to FIG. 7A, a locater 604 positioned on the outer wall of the insert 600 slides into the channel, or gap 605, between two teeth 606 and 607 of the clamping device 300. The locater retains the insert in place within the channel for example by the locator 604 dove-tailing between the two teeth 606 and 607. The insert is adapted to constrict in concert with the retaining device, that is, when a spung arm of the retention channel of the clamping device is displaced to the closed position by actuation of the lever. An array of inserts may be configured to have the same outer diameter (so as to be fitted within the same clamping device) with an inner diameter varying across the array. As such, the diameter of the clamping channel may be adjusted according to the shape of the object that requires retaining by selecting an insert from the array for placement within the retention channel of the retaining device. The insert may be sized to fit across the full depth of the channel or may be narrower as required. The shape of the locater may also be adapted, for example, to variations in the shape of the channel 605 formed between teeth 606 and 607 of the retention channel 133, which may come about, for example, from variation in the shape of the teeth.

The retaining arrangements of the present disclosure are suitable for retaining a variety of elements. For example, a series of clamping devices retained in a rail may be fixed to a wall surface, such as in a home garage or workshop, to clamp tools such as hammers, sledge hammers, spanners, shifters, mallets, chisels, screwdrivers, and the like. Individual clamps may be used to retain power tools such as battery drills and circular saws. Clamps may be adapted to secure power tools, for example battery powered hand tools, based on the particular dimensions, such as handle size and shape, of power tools of different brands. The retaining system may be adapted to retain an array of power tools of a particular brand. The retaining devices disposed on the retaining system may be interchanged depending on requirements of use. In a like manner clamps may be deployed in rails and attached to the walls of service and trade vehicles to organise tools and materials such as pipes and other conduits. The retaining system may be a portable retaining system which can be deployed at a work location, for example, a construction site, or a repair and/or maintenance location at a dwelling, business or industrial setting. The configuration of retaining devices on the retaining system, to hold a variety of tools, equipment and parts, suited to the particular task at hand, can facilitate, for example, access and use of tools retained by the system, and therefore overall work flow. An arrangement of retaining devices into an assembly may also be used, for example, as part of overhead roof racks or at the rear of vehicles to retain a range of different materials and objects. For example, the clamps may be configured to retain a bicycle to the rear of a vehicle.

In some embodiments the retaining devices are removable or interchangeable from the platform.

In some embodiments the retaining devices are integral with the platform. Suitably, the support structure of the retaining device may be integral with the platform.

Suitably, the retaining device of the present disclosure has a high grip force. Suitably, a single retaining device, with a substantially circular retention channel with a diameter of about 35 mm, may clamp an element up to about 30 kg element, where the element is subject to gravitational force when retained by the assembly with the retention channel oriented longitudinally. Suitably, a plurality of clamps may be used to distribute the load and retain elements of greater mass. Suitably the channel arms may be used latitudinally to distribute the load to the channel arms of the clamp assembly.

A pair clamps may be attached to a wall surface and a rail clamped between from which items may be hung. The clamps may be used to hold gymnasium equipment such as dumbbells. The clamps (which also may be referred to as clips depending on the application) may generally find application in any industrial setting where retention of tools and/or the arrangement of conduits is required. Examples, includes the mining and resources sector, audio installation, electrical installations, computing and data storage, hydroponics, irrigation, horticulture, agriculture, wastewater treatment and plumbing.

The clamping devices may be used to organises garden tools such as spades, shovels, forks, brooms, on the wall of a garden shed. Similarly, the clamping devices may be used to retain kitchen items such as cooking utensils, pots and pans, as well as bathroom items such as hairdryers or curling irons.

The retaining devices may be used as part of permanently arranged installations such as: solar installations as solar cable retention clips, cable, pipe and other conduit routing in vehicles and vessels such as cars, trucks, boats and aeroplanes. The clamps may be used in buildings to secure conduits and cabling, such as data cable conduits, electrical cables, audio cabling and the like.

Retaining device of the present disclosure may form part of a systematic retaining arrangement. For example, a series of clamp assemblies may be formed integrally with the lid of a vessel, such as a storage vessel. Suitably the clamp assemblies may be disposed around the perimeter of the lid, as part of a system that securely retains the lid to the vessel.

A variety of plastic may be selected for use in manufacture of the clamping devices of the present disclosure. The pivot pins, levers and linkage elements may be manufactured from alternative materials compared to the material from which the sprung arm is formed as these components are not subject to deformation.

Optional plastics for use in the manufacture of the clamping devices of the present disclosure include: nylon, polyethylene terephthalate (PET); blends of polyethylene terephthalate and polycarbonate (PC/PET); polyethylene terephthalate glycol (PET-G); polyphenylsulfone (PPSU); nylon; high-density polyethylene (HDPE); polyoxymethylene (acetal); ultra-high molecular weight polyethylene (UHMW); acrylonitrile butadiene styrene (ABS); acrylic; polycarbonate (PC).

When the retaining devices of the present disclosure are used under high load, the material of construction selected preferably does not exhibit excessive creep.

Suitably, the components of the clamping device are formed from a durable resilient plastic. In some embodiments the clamp body, pivot pins and lever arm are formed from PC/PET blends.

In some embodiments the clamp body, pivot pins and lever arm are formed from acetal.

Suitably, the different components of the retaining devices disclosed herein may be formed from different materials.

What is claimed is:

1. A retaining device comprising:
a retention channel adapted to receive an element for retention within the channel; and
an over-centre latch actuable to retain the element in the retention channel,
wherein the retention channel comprises;
a sprung arm, having a first inner channel wall; and
a channel arm, having a second inner channel wall;
wherein the first and second inner channel walls form a clamping surface within the retention channel, and wherein a sprung arm is displaceable between an open position to admit the element for clamping and a closed position to clamp the element with the clamping surface, by actuation of the over-centre latch; and
wherein the over-centre latch comprises:
a lever mechanism including:
a lever arm; and
a rotable linkage element,
said lever mechanism configured to actuate the retention channel between an open position and a closed position; and
wherein actuation of the lever mechanism to the closed position displaces the sprung arm from the open position to the closed position and applies a constrictive force upon the element to retain the element with the clamping surface.

2. The retaining device of claim 1, wherein the cross-sectional area of the retention channel opening is constricted by actuation of the lever mechanism to the closed position.

3. The retaining device of either claim 1, wherein the clamping surface is comprised of teeth.

4. The retaining device of claim 1, wherein a sprung arm includes a pivot hub.

5. The retaining device of claim 1, wherein actuation of the lever mechanism to the closed position pivots the linkage element of the lever mechanism urging the over-centre latch to the over-centre position.

6. The retaining device of claim 1, wherein the retaining device further comprises a static arm including a pivot hub, wherein the lever mechanism is formed between the pivot hub of a sprung arm and a pivot hub of a static arm.

7. The retaining device of claim 1, further comprising a support structure.

8. The retaining device of claim 7, wherein the sprung arm, channel arm and static arm extend from the support structure.

9. The retaining device of claim 7, wherein the support structure further comprises a base.

10. The retaining device of claim 1, wherein the over-centre latch is securable in a locked position when in an over-centre position.

11. The retaining device of claim 1, wherein the over-centre latch self-secures in an over-centre position at a stop of the over-centre mechanism.

12. The retaining device of claim 11, wherein the stop comprises a front shoulder of a pivot hub of the lever being impeded from further travel by the sprung arm.

13. The retaining device of claim 12, wherein the front shoulder of a pivot hub of the lever are impeded from further travel by a rear shoulder of sprung arm.

14. The retaining device of claim 1, wherein the retaining device is selected from a clamp or clip.

15. The retaining device of claim 1 further comprising an insert collar matingly engagable within the retention channel of the device wherein the collar reduces the cross-sectional area of the retention channel.

16. A retaining system comprising:
a retaining device according to claim 1; and
a platform for arranging one or more retaining devices thereon.

17. The retaining system of claim 16, wherein the retaining devices are secured on a surface of the platform by fastening a support structure of the retaining device to the platform.

18. The retaining system of claim 16, wherein the support structure of the retaining device is integral with the platform.

19. The retaining system of claim 16, wherein the retaining system comprises an array of retaining devices.

20. The retaining system of claim 16, wherein the system comprises a rail of retaining devices.
